(19) United States
(12) Patent Application Publication
(10) Pub. No.: US 2003/0032826 A1
(43) Pub. Date: Feb. 13, 2003

(54) Transesterification process for production of biodiesel

(75) Inventor: Milford A. Hanna, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Board of Regents of the University of Nebraska

(21) Appl. No.: 10/200,061

(22) Filed: Jul. 19, 2002

Related U.S. Application Data
(60) Provisional application No. 60/306,935, filed on Jul. 20, 2001.

(51) Int. Cl. C11B 3/00

(52) U.S. Cl. 554/124

(57) ABSTRACT

A process for the production of fatty acid esters from a triglyceride feedstock is provided. The process comprises introducing a catalyst and a triglyceride feed stream comprising the triglyceride feedstock into a reaction zone and introducing an alcohol into the feed stream within the reaction zone to form a product mixture comprising fatty acid esters, glycerol and unreacted alcohol. The feed stream into which the alcohol is introduced is characterized as having a Reynolds number of at least about 2100.

The invention further provides for a process and apparatus for introducing the alcohol into the triglyceride feed stream via a distributed feed system.

### CROSS REFERENCE TO RELATED APPLICATIONS

This application claims priority from U.S. Provisional Application Serial No. 60/306,935, filed Jul. 20, 2001, the entire text of which is hereby incorporated herein by reference.

### BACKGROUND OF THE INVENTION

The present invention relates generally to methods for producing fatty acid esters by the reaction of an ester and another organic compound with the exchange of alkoxy or acyl groups. More particularly, the present invention relates to methods for the transesterification of triglycerides such as vegetable oils or animal fats to produce fatty acid esters that may be used in the economical production of biodiesel.

Biodiesel is the common name for mono alkyl esters of long chain fatty acids derived from vegetable oils or animal fats. Biodiesel is a promising alternative fuel source suitable as a diesel fuel or diesel fuel lubricity additive because it is biodegradable, non-toxic and has low emission profiles as compared to conventional fuels. However, high raw material and processing costs have limited the widespread use of biodiesel.

The most common method of producing biodiesel is the base-catalyzed transesterification (or alcoholysis) of triglycerides such as vegetable oils and animal fats. The transesterification reaction involves reacting the triglyceride with an alcohol to form fatty acid esters and glycerol. The reaction is sequential wherein the triglycerides are reduced to diglycerides, monoglycerides and then to glycerol with a mole of ester liberated at each step. Transesterification of oils and fats also has been described in connection with the production of detergents, cosmetics and lubricating agents.

The transesterification process is most commonly conducted in a batch reactor. While batch processes are easy to control, batch processing for the transesterification of vegetable oils and animal fats is generally not cost effective due to inefficient mixing methods and long reaction times. For example, in U.S. Pat. No. 4,303,590, Tanaka et al. describe a two-step transesterification of fatty acid glycerides with a lower alcohol for the preparation of lower alkyl esters of fatty acids and glycerol. The first transesterification reaction is conducted at or near the boiling temperature of the lower alcohol for about 0.5 to about 2 hours. The glycerol produced is then separated from the fatty acid esters by settling the mixture for about 1 to 15 minutes at about 40° to about 70° C. and decanting the crude fatty acid ester layer. The crude fatty acid ester layer containing unreacted glycerides is subjected to a second transesterification reaction with about 8 to about 20% alcohol and about 0.2 to about 0.5% alkali catalyst for another 5 to 60 minutes, achieving an overall conversion to fatty acid esters of about 98%.

Continuous transesterification processes have been suggested to help reduce processing time. However, these prior art continuous processes have not provided efficient mixing of the transesterification reaction mass to substantially reduce the time and cost associated with producing biodiesel. For example, Trent, U.S. Pat. No. 2,383,632, discloses a continuous transesterification process for the production of fatty acid esters from fats and oils and their further use in the production of soap. The reaction is described as introducing a fat or an oil, an alcohol and a catalyst into a contactor coil and turbulently mixing the reactants in the coil for about ten to forty minutes at room temperature. The mixture is then passed to an alcoholysis tank comprising a vaporization chamber wherein the mixture is heated to about 125° C. and any unreacted alcohol is vaporized to produce a product mixture comprising fatty acid esters and glycerol substantially free of the reactant alcohol. The product mixture is neutralized in the center portion of the tank and then separated into an ester component and a glycerol component in a separation chamber comprising the lower portion of the alcoholysis tank.

Another example, U.S. Pat. No. 2,383,579, discloses a continuous transesterification process whereby a fatty glyceride, an alcohol and a catalyst are pre-mixed in a mixing chamber to partially esterify the glyceride. The partially esterified mixture is removed from the mixing chamber and pumped through a reaction coil at 100° C. to produce a product mixture comprising fatty acid esters, glycerol and unreacted alcohol. The product mixture is then heated to about 110° C. and loaded into a packed column for separation of the alcohol. The glycerol and fatty acid esters are separated and the fatty acid esters are further washed and dried under vacuum.

### SUMMARY OF THE INVENTION

Among the several objects of this invention, therefore, may be noted the provision of a process for the transesterification of triglycerides such as a vegetable oil or an animal fat with an alcohol wherein fatty acid esters are produced; such a process that provides for more efficient mixing of reactants; such a process wherein less excess alcohol is required; such a process which may be practiced continuously; and such a process which is useful in the economical production of biodiesel.

Briefly, therefore, the present invention is directed to a process for the production of fatty acid esters from a triglyceride feedstock comprising animal fats, vegetable oils or mixtures thereof. The process comprises introducing a triglyceride feed stream comprising the triglyceride feedstock into a reaction zone. An alcohol is introduced into the triglyceride feed stream within the reaction zone and reacted with the triglyceride feedstock to form a product mixture comprising fatty acid esters, glycerol and unreacted alcohol. The process is further defined in that a catalyst is introduced into the reaction zone and the triglyceride feed stream into which the alcohol is introduced is characterized as having a Reynolds number of at least about 2100.

The invention is further directed to a process for the production of fatty acid esters by transesterification of a triglyceride feedstock with an alcohol in the presence of a catalyst. The process comprises introducing a a triglyceride feed stream comprising the triglyceride feedstock into a first mixing zone of a reaction zone comprising two or more mixing zones in series. The catalyst is introduced into the reaction zone and the alcohol is introduced into the triglyceride feed stream within the first of the mixing zones. The alcohol and the triglyceride feedstock are reacted in the reaction zone to produce an intermediate reaction mixture stream comprising fatty acid esters, glycerol, unreacted alcohol and unreacted triglyceride feedstock. The intermediate reaction mixture stream is introduced into a second of the series of mixing zones and the alcohol is introduced into the intermediate reaction mixture stream within the second mixing zone to react the unreacted triglyceride feedstock in the intermediate reaction mixture stream with the alcohol introduced into the intermediate reaction mixture stream. After the alcohol is reacted with the intermediate reaction mixture stream, a final reaction product mixture comprising fatty acid esters, glycerol and unreacted alcohol is withdrawn from the reaction zone.

The present invention is still further directed to an apparatus for the continuous production of fatty acid esters from a triglyceride feedstock. The apparatus comprises a reaction conduit comprising two or more mixing zones in series for reacting a feed stream comprising the triglyceride feedstock with an alcohol. The apparatus further comprises means for introducing an alcohol and a catalyst into the reaction zone, preferably into the first of the mixing zones and into at least one or more of the mixing zones succeeding the first mixing zone in the series of mixing zones.

### BRIEF DESCRIPTION OF THE DRAWINGS

FIG. 1 is a schematic flow diagram illustrating one embodiment of the present invention.

FIG. 2 is a schematic of a venturi injector used in one embodiment of the present invention.

### DETAILED DESCRIPTION OF THE PREFERRED EMBODIMENTS

In accordance with the present invention, a process has been discovered for the economical production of fatty acid esters by the catalyzed transesterification of triglyceride feedstocks with an alcohol. The transesterification process may be conducted continuously and in a manner which provides more efficient mixing of the reaction mass. The fatty acid esters produced are beneficial in producing detergents, cosmetics, lubricating agents and fuels such as biodiesel. The transesterification process comprises reacting a triglyceride feedstock with an alcohol in three consecutive, reversible reaction steps. The triglyceride is converted stepwise to a diglyceride, a monoglyceride and finally to glycerol with a fatty acid ester liberated at each step. Although the reaction steps are reversible, the equilibrium lies toward the production of fatty acid esters and glycerol. Preferably the transesterification reaction is catalyzed to improve the reaction rates and the yield of esters. The overall transesterification reaction proceeds generally in accordance with the following equation:

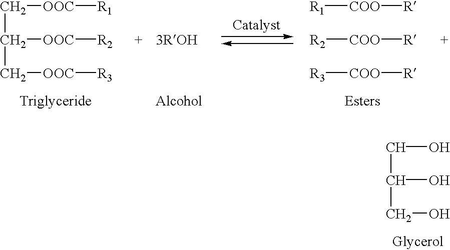

The process of the invention is implemented by contacting a triglyceride feed stream comprising the triglyceride feedstock with an alcohol and a catalyst in a reaction zone. In accordance with the present invention, it has been found that more efficient mixing of reactants and more favorable reaction kinetics can be achieved to provide far shorter residence times, increased throughput and, therefore, a more economical process for the production of fatty acid esters from triglycerides. More efficient mixing of the reaction mass and the attendant benefits are provided by introducing the alcohol into the triglyceride feed stream while the feed stream is under turbulent flow conditions within the reaction zone. Stated another way, the stream into which the alcohol is introduced is characterized as having a Reynolds number of at least about 2100. Reynolds numbers in excess of about 2100 are generally associated with turbulent flow conditions. The Reynolds number (Re) for the triglyceride feed stream is defined according to the following equation:

Re=pvD/μ

where p represents the density of the triglyceride feed stream, v represents the average velocity of the feed stream flow, μ is the viscosity of the feed stream and D is the hydraulic diameter of the flow area within the reaction zone at the location the alcohol is introduced into the triglyceride feed stream. Without being held to a particular theory, it is believed that the practice of introducing the alcohol into the turbulent flow of the triglyceride feed stream provides a substantially even distribution of the reactants throughout the resulting reaction mass and a large interfacial reaction area, which results in both an increased reaction rate and improved overall conversion efficiency.

As used herein, the term triglyceride has its ordinary meaning in the art as a glycerol having all of its hydroxy groups substituted by fatty acids. Examples of suitable triglyceride feedstocks for use in the present invention include animal fats such as beef tallow and vegetable oils such as corn, soybean, rapeseed, peanut, sunflower and canola oils. Used cooking oils also may be used as a triglyceride feedstock. Typically, the triglyceride feedstock will be selected based on cost and availability. However, vegetable oils are generally preferred over animal fats. The triglyceride feed stream is preferably substantially anhydrous, having a water content of less than about 1%, more preferably less than about 0.06% by weight. Although the feed stream may have a higher water content as described below, water in the feed stream may saponify the reactants, thus reducing the yield of fatty acid esters. Preferably, the feed stream has a free fatty acid content of less than about 0.5% by weight and is substantially free of particulate impurities. Should the feed stream contain particulate impurities, it may be filtered. Likewise, feed streams having a free fatty acid content of greater than about 0.5% by weight may be subjected to alkaline treatment to remove the excess free fatty acids. Preferably, the triglyceride feed stream introduced into the reaction zone is heated to a temperature of from about 70° to about 200° C.

Alcohols suitable for use in the invention typically comprise any primary and secondary monohydric aliphatic alcohols having one to eight carbon atoms. Preferred alcohols for use in the transesterification process are methanol, ethanol, propanol, butanol and amyl alcohol, with methanol and ethanol being more preferred. A particularly preferred alcohol, for example, is methanol because it is of low cost, it reacts quickly and catalysts such as NaOH readily dissolve in it.

Typical catalysts for the transesterification reaction may include alkalis, acids and enzymes. Alkali metal catalysts suitable for the transesterification reaction include NaOH, KOH, carbonates and corresponding sodium and potassium alkoxides such as sodium methoxide, sodium ethoxide, sodium propoxide and sodium butoxide. Suitable acid catalysts include sulfuric acid, hydrochloric acid and sulfonic acids. Further, biocatalysts such as lipases can be used in the transesterification reaction.

Generally, alkali catalysts are preferred over acid catalysts because alkali catalysts typically have faster reaction times. However, for alkali-catalyzed transesterification, it is essential that the triglycerides have low water and free fatty acid concentrations as described above. For example, if the water content of the triglyceride feed stream is greater than about 1% or the free fatty acid content of the triglyceride feed stream is greater than about 0.5%, an alkali catalyst will promote saponification of the triglycerides in the triglyceride feed stream, producing soap and reducing the yield of fatty acid esters. Triglyceride feed streams having a higher water or free fatty acid content can still be used in the present invention; however, it is generally preferred to use acid catalysts for triglyceride feed streams having a water content of greater than about 1% and a free fatty acid content of greater than about 4 to about 6% to reduce saponification.

It is important to note that catalyst may be introduced into the reaction zone in any of a variety of methods which one of skill in the art would deem suitable for introducing catalyst into a reaction mass. For example, the catalyst may be introduced into the reaction zone separately from the other reactants or the catalyst may be introduced into the reaction zone simultaneously with either the triglyceride feed stream or the alcohol. When introduced simultaneously with the triglyceride feed stream, the catalyst and the triglyceride feedstock may be pre-mixed to form a catalyst-containing triglyceride feed stream to be introduced into the reaction zone. Likewise, when catalyst is introduced into the reaction zone simultaneously with the alcohol, the alcohol and catalyst may be pre-mixed to form an alcohol-catalyst solution to be introduced into the reaction zone. For convenience, the majority of the following discussion focuses on introducing the catalyst into the reaction zone simultaneously with the alcohol, preferably as a pre-mixed alcohol-catalyst solution. However, as described above, the description of such an embodiment is not intended to be limiting as to how catalyst may be introduced into the reaction zone.

The reaction zone and the means for introducing the alcohol and catalyst into the feed stream may take on various configurations. For example, the reaction zone may be disposed within a conventional pipeline reactor wherein the alcohol and the catalyst are injected or sprayed into the triglyceride feed stream through one or more ports in the wall of the reactor. Alternatively, a venturi injector may be employed wherein the alcohol and the catalyst are drawn into the triglyceride feed stream by the pressure differential created as the triglyceride feed stream is accelerated through the throat of the venturi. Experience to date suggests that the length of conventional pipeline reactor arrangements required to effect the transesterification reaction and the energy input necessary to establish turbulent flow conditions within the feed stream into which the alcohol and catalyst are introduced may make such reactor configurations less practical. Accordingly, the reaction zone preferably comprises a venturi injector as described in greater detail below.

In a particularly preferred embodiment, the alcohol is introduced into a plurality of mixing zones in series within the reaction zone. It has been found that introducing the alcohol into at least two or more mixing zones in series (i.e., in a distributed feed arrangement) allows for more efficient and more intimate contact between the reactants and the catalyst. Thus, introducing the alcohol and catalyst into two or more mixing zones in series within the reaction zone increases the reaction rate and decreases the residence time necessary to achieve acceptable conversion. It also has been found that introducing the alcohol and catalyst into multiple mixing zones within the reaction zone advantageously reduces the amount of alcohol reactant necessary to effect the reaction.

There is no limit as to how many mixing zones may be included within the reaction zone. However, there is generally no advantage to combining more than about twelve mixing zones in series for carrying out the present invention. A preferred embodiment of the present invention includes from two to six mixing zones in series, with a reaction apparatus comprising four mixing zones in series being most preferred. In any case, one skilled in the art working with the present invention would be able to optimize the number of mixing zones to be combined in series based upon the appropriate diameter piping and flow rates associated with a particular apparatus.

Further, it is important to note that when using a distributed feed arrangement in which the reaction zone comprises a series of mixing zones, catalyst may be introduced into the reaction zone in a variety of ways. As described above, catalyst may enter the reaction zone alone or simultaneously with either the triglyceride feedstock or the alcohol. Likewise, in a distributed feed arrangement, catalyst may be introduced into one or more of the mixing zones within the reaction zone. Thus, in one embodiment, catalyst is introduced into the reaction zone as part of a catalyst-containing triglyceride feed stream that is introduced into the first mixing zone of the series of mixing zones. In another embodiment, the catalyst is introduced into the reaction zone simultaneously with the alcohol into the triglyceride feed stream within the first mixing zone of the series of mixing zones. Alternatively, catalyst may be introduced into the triglyceride feed stream within the first mixing zone of the series of mixing zones with additional catalyst introduced into the intermediate reaction mixture stream within one or more of the mixing zones after the first mixing zone of the series of mixing zones.

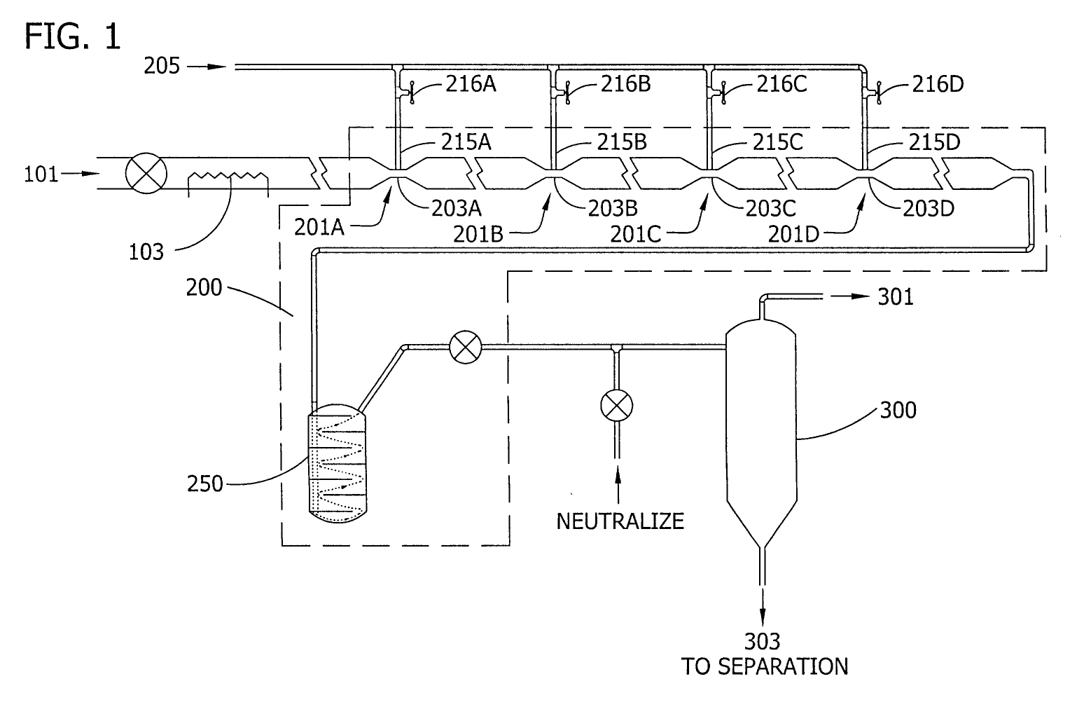

The process of the present invention will now be more particularly described with reference to a preferred embodiment of the invention schematically illustrated in FIG. 1 and comprising four mixing zones in series. The process comprises heating a triglyceride feed stream 101 comprising the triglyceride feedstock in a heater 103 to a temperature of from about 70° to about 200° C. The heated feed stream is introduced into a reaction zone 200 generally circumscribed by the dashed line in FIG. 1 and comprising four mixing zones 201A-201D associated with venturi injectors 203A-203D. The heated triglyceride feed stream enters the reaction zone 200 through the first venturi injector 203A. An alcohol and a catalyst (preferably an alcohol-catalyst solution 205) is also introduced into each mixing zone 201A-201D through the alcohol-catalyst inlets 215A-215D of each venturi injector 203A-203D.

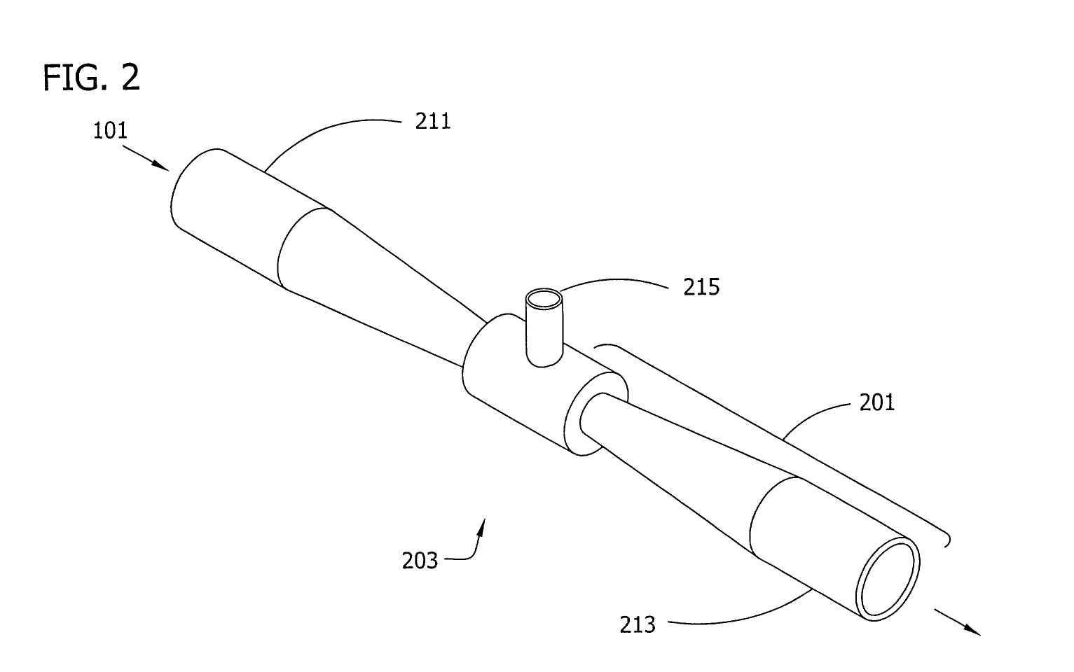

Referring to FIG. 2, a representative venturi injector 203 comprises an upstream end 211, a downstream end 213 and an alcohol-catalyst inlet 215. The diameter of the flow area within the venturi injector 203 gradually decreases along its longitudinal axis from its upstream end 211 to the alcohol-catalyst inlet 215. In the mixing zone 201, generally downstream of the alcohol-catalyst solution inlet 215, the diameter of the flow area within the venturi injector gradually increases along its longitudinal axis toward its downstream end 213. In this fashion, the flow within the venturi injector is accelerated into the mixing zone.

Although not shown, it should be understood that the alcohol and catalyst may be introduced through separate inlets. In other words, the venturi injector 203 may include more than one inlet 215 for separately introducing alcohol and catalyst.

Referring again to FIG. 1, in each mixing zone 201A-201D, the triglyceride feedstock and alcohol are reacted in the presence of the catalyst to form an intermediate reaction mixture stream comprising fatty acid esters, glycerol, unreacted triglyceride feedstock, catalyst and unreacted alcohol. The intermediate reaction mixture stream produced in the first mixing zone 201A is introduced into the second mixing zone 201B. Additional alcohol and catalyst are introduced into the intermediate reaction mixture stream within each mixing zone 201B-201D after the first mixing zone 201A such that the triglyceride feedstock and the alcohol are reacted in each mixing zone.

Preferably, in order to achieve enhanced mixing of the transesterification reaction mass in accordance with the present invention, the triglyceride feed stream is introduced into the reaction zone 200 at a flow rate sufficient to provide a Reynolds number of at least about 2100 within at least one of the mixing zones 201A-201D such that the alcohol and catalyst are introduced into the corresponding feed stream or intermediate product mixture stream under turbulent flow conditions. Without being bound to a particular theory, it is believed that turbulence within the venturi arrangement of the reaction zone, and particularly within the mixing zones within the reaction zone, causes the alcohol and the catalyst to be dispersed into the flow of reaction mass in the form of fine droplets. These fine droplets allow for improved mixing associated with the present invention as the alcohol and the catalyst can be substantially evenly distributed throughout the reaction mass to provide a large interfacial reaction area that results in an increased reaction rate and improved overall conversion efficiency.

In accordance with a preferred embodiment of the invention, the triglyceride feed stream is introduced into the reaction zone at a flow rate sufficient to provide a Reynolds number of at least about 2100 in the stream within each mixing zone 201A-201D into which the alcohol and catalyst are introduced. In another embodiment, the flow rate of the triglyceride feed stream is sufficient to provide a Reynolds number in excess of 2100 up to about 4000 in the stream within each mixing zone 201A-201D into which the alcohol and catalyst are introduced. Further, in another embodiment, the flow rate of the triglyceride feed stream is sufficient to provide a Reynolds number in excess of 4000 in the stream within each mixing zone 201A-201D into which the alcohol and catalyst are introduced. Although the present invention may be practiced with triglyceride feed streams and/or intermediate reaction mixture streams having even higher Reynolds numbers, experience to date suggests that the benefits of operating at a Reynolds number much above 4000 are diminished by the increased energy input requirements.

The pressure differential created by the flow as it accelerates through the throat of venturi injectors 203A-203D draws alcohol-catalyst solution from the inlet 215A-215D into the mixing zone 201A-201D. Maintaining a high Reynolds number as described above is important to ensure that the alcohol and the catalyst are drawn into the venturi at the desired rate. Preferably, the amount of alcohol-catalyst solution entering the mixing zones 201A-201D is controlled by valves 216A-216D such that alcohol-catalyst solution is introduced at a rate sufficient to provide a ratio of about 1 part by weight of alcohol-catalyst solution to about 10 parts by weight of triglyceride present within the reaction zone; or, more particularly, a mole ratio of alcohol to triglyceride within the reaction zone of from about 3:1 to about 6:1.

Typically, traditional transesterification processes have required a molar ratio of alcohol to triglyceride of about 6:1 or about two times the stoichiometric amount of alcohol to ensure adequate ester yield for the production of fatty acid esters. However, in the present invention, it has been found that because of the more efficient mixing provided by introducing the alcohol into a turbulent flow and distributing the alcohol reactant load between two or more mixing zones in series, less excess alcohol is required to effect the reaction. It has been found that in the operation of the present invention, the alcohol to triglyceride molar ratio may be as low as about 4:1, preferably about 5:1, while still achieving an adequate yield of fatty acid esters within a reasonably short residence time within the reaction zone. Thus, the present invention provides a process that uses less alcohol reactant, resulting in a more economical method of producing fatty acid esters as compared to the prior art.

The amount of catalyst to be used in conducting the transesterification reaction ranges from about 0.1 to about 1 percent by weight, more preferably from about 0.3 to about 0.5 percent by weight, of triglyceride charged to the reaction zone. However, it is important to note that using too much catalyst is undesirable because excess catalyst must be neutralized after the reaction is completed.

Referring again to FIG. 1, the intermediate reaction mixture stream exiting the last mixing zone 201D generally comprises fatty acid esters, glycerol, excess alcohol reactant, catalyst and unreacted triglycerides, diglycerides and monoglycerides and is transferred to a buffer tank 250 as the final component of the reaction zone 200. The intermediate reaction mixture stream introduced into buffer tank 250 is neutralized to halt the reaction and form a final reaction product mixture containing fatty acid esters, glycerol and unreacted alcohol. The final reaction product mixture is withdrawn from the reaction zone 200 and transferred to an evaporator 300 wherein unreacted alcohol is vaporized for recycle and reuse as an alcohol recovery stream 301 in the reaction zone 200.

Temperatures and pressures within the evaporator 300 are not critical and may include any temperatures or pressures sufficient for vaporization and removal of the respective alcohol used in the reaction.

After evaporation, the remaining product stream 303 is collected and the fatty acid esters are separated from the glycerol. Separation may be achieved by any means generally known in the art, preferably by gravity separation and decantation or centrifugation. The glycerol has a higher density than the fatty acid esters which results in a rapid and distinct separation. Importantly, the separated glycerol may be recovered as a valuable industrial chemical that may be further refined to a high quality glycerol. The separated fatty acid ester product is typically washed with water and then dried. It has been found that the process of the present invention achieves an overall conversion of triglyceride feedstocks to fatty acid esters of about 80% to about 97%.

What is claimed:

1. A process for the production of fatty acid esters from a triglyceride feedstock, the process comprising:
introducing a triglyceride feed stream comprising the triglyceride feedstock into a reaction zone;
introducing a catalyst into the reaction zone;
introducing an alcohol into the triglyceride feed stream within the reaction zone, the triglyceride feed stream into which the alcohol is introduced being characterized as having a Reynolds number of at least about 2100; and
reacting the triglyceride feedstock and the alcohol to form a product mixture comprising fatty acid esters, glycerol and unreacted alcohol.

2. A process as set forth in claim 1, wherein the catalyst is introduced into the triglyceride feed stream within the reaction zone.

3. A process as set forth in claim 2, wherein the alcohol and the catalyst are simultaneously introduced into the triglyceride feed stream.

4. A process as set forth in claim 1 further comprising:
neutralizing the product mixture;
evaporating unreacted alcohol from the product mixture; and
separating said fatty acid esters from said glycerol in said product mixture.

5. A process as set forth in claim 4 wherein the evaporated alcohol is recycled to the reaction zone.

6. A process as set forth in claim 1 wherein the triglyceride feedstock comprises a vegetable oil, an animal fat or a mixture thereof.

7. A process as set forth in claim 6 wherein the triglyceride feedstock is selected from the group consisting of beef tallow, corn oil, soybean oil, rapeseed oil, peanut oil, sunflower oil, canola oil and mixtures thereof.

8. A process as set forth in claim 1 wherein the triglyceride feedstock comprises used cooking oil.

9. A process as set forth in claim 1 wherein the alcohol is a primary or secondary monohydric aliphatic alcohol having one to eight carbon atoms.

10. A process as set forth in claim 9 wherein the alcohol is selected from the group consisting of methanol, ethanol, propanol, butanol and amyl alcohol.

11. A process as set forth in claim 9 wherein the alcohol is methanol or ethanol.

12. A process as set forth in claim 9 wherein the alcohol is methanol.

13. A process as set forth in claim 1 wherein the catalyst comprises an alkali metal.

14. A process as set forth in claim 13 wherein the catalyst is selected from the group consisting of an alkali metal hydroxide, an alkali metal carbonate, an alkali metal alkoxide and mixtures thereof.

15. A process as set forth in claim 14 wherein the alkali metal is selected from the group consisting of sodium and potassium.

16. A process as set forth in claim 14 wherein the catalyst is potassium hydroxide or sodium hydroxide.

17. A process as set forth in claim 14 wherein the catalyst is sodium hydroxide.

18. A process as set forth in claim 1 wherein the catalyst comprises an acid selected from the group consisting of sulfuric acid, hydrochloric acid, sulfonic acid and mixtures thereof.

19. A process as set forth in claim 1 wherein the catalyst comprises a biocatalyst.

20. A process as set forth in claim 19 wherein the catalyst is a lipase.

21. A process as set forth in claim 1 wherein the molar ratio of alcohol to triglyceride introduced into the reaction zone is less than about 6:1.

22. A process as set forth in claim 21 wherein the molar ratio of alcohol to triglyceride introduced into the reaction zone is about 5:1.

23. A process as set forth in claim 22 wherein the molar ratio of alcohol to triglyceride introduced into the reaction zone is about 4:1.

24. A process as set forth in claim 1 wherein the triglyceride feed stream into which the alcohol is introduced is characterized as having a Reynolds number of from about 2100 to about 4000.

25. A process as set forth in claim 1 wherein the triglyceride feed stream into which the alcohol is introduced is characterized as having a Reynolds number of at least about 4000.

26. A process as set forth in claim 1 wherein the reaction zone comprises a venturi injector.

27. A continuous process for the production of fatty acid esters by transesterification of a triglyceride feedstock with an alcohol in the presence of a catalyst, the process comprising:
introducing a triglyceride feed stream comprising the triglyceride feedstock into a first mixing zone of a reaction zone comprising two or more mixing zones in series;
introducing the alcohol into the triglyceride feed stream within the first mixing zone of said series of mixing zones;
introducing the catalyst into the reaction zone;
reacting the triglyceride feedstock and the alcohol in the reaction zone to produce an intermediate reaction mixture stream comprising fatty acid esters, glycerol and unreacted triglyceride feedstock and alcohol;
introducing the intermediate reaction mixture stream into a second mixing zone of said series of mixing zones;
introducing the alcohol into the intermediate reaction mixture stream within the second mixing zone of said series of mixing zones;
reacting the unreacted triglyceride feedstock in the intermediate reaction mixture stream with the alcohol introduced into the intermediate reaction mixture stream in the reaction zone; and
withdrawing a final reaction product mixture containing fatty acid esters, glycerol and unreacted alcohol from the reaction zone.

28. A process as set forth in claim 27 wherein the triglyceride feed stream into which the alcohol is introduced is characterized as having a Reynolds number of at least about 2100.

29. A process as set forth in claim 28 wherein the triglyceride feed stream into which the alcohol is introduced is characterized as having a Reynolds number of from about 2100 to about 4000.

30. A process as set forth in claim 28 wherein the triglyceride feed stream into which the alcohol is introduced is characterized as having a Reynolds number of at least about 4000.

31. A process as set forth in claim 27 wherein the catalyst is introduced into the triglyceride feed stream within the first mixing zone of said series of mixing zones.

32. A process as set forth in claim 31 wherein the alcohol and catalyst are simultaneously introduced into the triglyceride feed stream within the first mixing zone of said series of mixing zones.

33. A process as set forth in claim 31 wherein additional catalyst is introduced into intermediate reaction mixture stream within the second mixing zone of said series of mixing zones.

34. A process as set forth in claim 27 wherein the reaction zone comprises from two to twelve mixing zones in series.

35. A process as set forth in claim 34 wherein the alcohol is introduced into the intermediate reaction mixture stream within each mixing zone after the first mixing zone of said series of mixing zones.

36. A process as set forth in claim 35 wherein the catalyst is introduced into the triglyceride feed stream within the first mixing zone and additional catalyst is introduced into the intermediate reaction mixture stream within one or more mixing zones after the first mixing zone of said series of mixing zones.

37. A process as set forth in claim 35 wherein additional catalyst is introduced into the intermediate reaction mixture stream within each mixing zone after the first mixing zone of said series of mixing zones.

38. A process as set forth in claim 35 wherein the reaction zone comprises four mixing zones in series.

39. A process as set forth in claim 38 wherein each mixing zone is provided by a venturi injector.

40. A process as set forth in claim 35 wherein the triglyceride feed stream and the intermediate reaction mixture stream into which the alcohol is introduced are characterized as having a Reynolds number of at least about 2100.

41. A process as set forth in claim 40 wherein the triglyceride feed stream and the intermediate reaction mixture stream into which the alcohol is introduced is characterized as having a Reynolds number of from about 2100 to about 4000.

42. A process as set forth in claim 40 wherein the triglyceride feed stream and the intermediate reaction mixture stream into which the alcohol is introduced is characterized as having a Reynolds number of at least about 4000.

43. A process as set forth in claim 27 wherein the triglyceride feedstock comprises a vegetable oil, an animal fat or a mixture thereof.

44. A process as set forth in claim 43 wherein the triglyceride feedstock is selected from the group consisting of beef tallow, corn oil, soybean oil, rapeseed oil, peanut oil, sunflower oil, canola oil and mixtures thereof.

45. A process as set forth in claim 27 wherein the triglyceride feedstock comprises used cooking oil.

46. A process as set forth in claim 27 wherein the alcohol is a primary or secondary monohydric aliphatic alcohol having one to eight carbon atoms.

47. A process as set forth in claim 46 wherein the alcohol is selected from the group consisting of methanol, ethanol, propanol, butanol and amyl alcohol

48. A process as set forth in claim 46 wherein the alcohol is methanol or ethanol.

49. A process as set forth in claim 46 wherein the alcohol is methanol.

50. A process as set forth in claim 27 wherein the catalyst comprises an alkali metal.

51. A process as set forth in claim 50 wherein the catalyst is selected from the group consisting of an alkali metal hydroxide, an alkali metal carbonate, an alkali metal alkoxide and mixtures thereof.

52. A process as set forth in claim 50 wherein the alkali metal is selected from the group consisting of sodium and potassium.

53. A process as set forth in claim 52 wherein the catalyst is sodium hydroxide or potassium hydroxide.

54. A process as set forth in claim 52 wherein the catalyst is sodium hydroxide.

55. A process as set forth in claim 27 wherein the catalyst comprises an acid selected from the group consisting of sulfuric acid, hydrochloric acid, sulfonic acid and mixtures thereof.

56. A process as set forth in claim 27 wherein the catalyst comprises a biocatalyst.

57. A process as set forth in claim 56 wherein the catalyst is a lipase.

58. A process as set forth in claim 27 wherein the molar ratio of alcohol to triglyceride feedstock introduced into the reaction zone is less than about 6:1.

59. A process as set forth in claim 58 wherein the molar ratio of alcohol to triglyceride feedstock introduced into the reaction zone is about 5:1.

60. A process as set forth in claim 59 wherein the molar ratio of alcohol to triglyceride feedstock introduced into the reaction zone is about 4:1.

61. A process as set forth in claim 27 further comprising:
neutralizing the final product mixture;
evaporating unreacted alcohol from the final product mixture; and
separating the fatty acid esters from the glycerol contained in said final product mixture.

62. A process as set forth in claim 61 wherein the evaporated alcohol is recycled to the reaction zone.
